(19) United States
(12) Patent Application Publication
(10) Pub. No.: US 2024/0390959 A1
(43) Pub. Date: Nov. 28, 2024

(54) COUPLED MEDIUM-LOW TEMPERATURE FLUE GAS PROCESSING APPARATUS FOR FLY ASH WASHING

(71) Applicant: Nanjing Institute of Environmental Sciences, MEE, Nanjing (CN)

(72) Inventors: Houhu ZHANG, Nanjing (CN); Bing MA, Nanjing (CN); Hao ZHOU, Nanjing (CN); Xiaofei YAN, Nanjing (CN); Guodong KANG, Nanjing (CN); Yi WANG, Nanjing (CN)

(73) Assignee: Nanjing Institute of Environmental Sciences, MEE, Nanjing (CN)

(21) Appl. No.: 18/630,274

(22) Filed: Apr. 9, 2024

(30) Foreign Application Priority Data
May 24, 2023 (CN) 202310591799.5

(51) Int. Cl. B09B 3/38; B09B 101/30

(52) U.S. Cl. CPC B09B 3/38; B09B 2101/30

(57) ABSTRACT

A coupled medium-low temperature flue gas processing apparatus for fly ash washing includes a reactor and scraping rings. In the present disclosure, arranging the scraping rings can scrape the fly ash adhered to the inside of the reactor and bring the scraped fly ash into a mixing liquor to prevent the fly ash from adhering and accumulating, which not only results in the decrease of the fly ash content participating in the reaction, and the difficulty to react with water completely, but also the fly ash adhered to the inside of the reactor will form a thick object after mixing with the water, once the thick object is dried, the adhesive capacity thereof is greatly enhanced.

### CROSS-REFERENCE TO RELATED APPLICATION

The application claims priority to Chinese Patent Application No. 202310591799.5, filed on May 24, 2024, which is incorporated herein by reference in its entirety.

### TECHNICAL FIELD

The present disclosure relates to the technical field of flue gas processing, and in particular to a coupled medium-low temperature flue gas processing apparatus for fly ash washing.

### BACKGROUND

With a particle size of generally 1-100 m, a tiny ash particle discharged from a combustion process of a fuel (mainly coal) is also known as coal ash or soot, and fine solid particulate matters in a smoke ash content produce through fuel combustion, such as the fine ash collected by a coal-fired power plant from a flue gas, fly ash is formed in a manner that pulverized coal is cooled after entering a hearth of 1300-1500° C. and being subjected to heat absorption by a heat surface under a suspension combustion condition. Due to the action of a surface tension, the fly ash is mostly spherical, smooth in surface and less in micropore, some fly ash is adhered due to collision with each other under a molten state to become a cellular composite particle with a rough surface and more corner angles, and the chemical composition of the fly ash is associated with coal components, a coal particle size, a boiler shape, combustion conditions and a collection mode, etc.

When being processed, the fly ash needs to be washed, the fly ash from domestic waste incineration needs to be added in water during washing, the fly ash is mixed with the water at a mass ratio of 1:4, while a mixing efficiency is directly proportional to a temperature, and the mixing efficiency thereof can be enhanced greatly if an afterheat temperature of the flue gas can be used; however, the fly ash is easy to splash in a mixing process, causing that the fly ash is adhered to an inner wall of a mixing apparatus, and if the fly ash cannot be cleaned in time, an adhesive capacity thereof is enhanced greatly once dried, thus leading to the increase of a cleaning difficulty in the later period.

To cope with the foregoing issue, a coupled medium-low temperature flue gas processing apparatus for fly ash washing is urgently needed at present.

### SUMMARY

The objective of the present disclosure is to provide a coupled medium-low temperature flue gas processing apparatus for fly ash washing, to solve the issue proposed in the background art.

To implement the foregoing objective, a coupled medium-low temperature flue gas processing apparatus for fly ash washing is provided, including a reactor, where a stirring motor is arranged in a middle of a top end of the reactor, feeding tubes that are used for performing material guide work of fly ash and water are arranged on both sides of the top end of the reactor, an air inlet tube used for performing flue gas introduction is arranged on a side of the reactor, scraping rings are arranged at a position where an inner end of the reactor is close to a middle of the reactor, a bottom end of the stirring motor is coaxially connected with threaded rods that pass through middle positions of the scraping rings and keep a threaded connection with the scraping rings, bottom ends of the threaded rods are coaxially connected with stirring rods, and a collection assembly used for collecting a mixture of the fly ash and the water is arranged at a bottom end of the reactor.

Edge positions of bottom ends of the scraping rings keep fitting with the inside of the reactor, the stirring motor drives the stirring rods to rotate through the threaded rods so as to perform a stirring treatment on the fly ash and the water, when the stirring motor rotates forwards during stirring, the scraping rings are driven to move down along the inside of the reactor through the threaded rods, so the fly ash adhered to the inside of the reactor is scraped at the edge positions of the bottom ends of the scraping rings, and when the stirring motor rotates reversely, the scraping rings are driven to move up along the inside of the reactor through the threaded rods, to restore an initial position.

As a further improvement of the technical solution, the collection assembly includes a filter funnel that is sleeved at the bottom end of the reactor and keeps communicating with the inner end of the reactor, a valve is arranged at a position where the inside of the reactor is close to the bottom end of the reactor, the valve is used for controlling a switch between the bottom end of the reactor and the inner end of the filter funnel, and a liquid tank is arranged at a bottom end of the filter funnel.

As a further improvement of the technical solution, fixed rings are arranged at bottom ends of the feeding tubes, section sizes of the fixed rings are greater than those of the feeding tubes, connecting rings are sleeved at positions where the feeding tubes are close to the bottom end, a plurality of buffer springs are connected between the connecting rings and the fixed rings, a bottom end of the air inlet tube is an inclined structure, and the air inlet tube stretches downwards into the inner end of the reactor.

As a further improvement of the technical solution, a protective disk is arranged at an inner end of the air inlet tube, and a section size of the protective disk keeps fitting with that of the inner end of the air inlet tube.

As a further improvement of the technical solution, a threaded ring is arranged at a top end of the filter funnel, an internal thread is arranged inside the bottom end of the reactor, and the threaded ring keeps a threaded connection with the internal thread.

As a further improvement of the technical solution, wedge rings are arranged at the bottom ends of the scraping rings, and section sizes of bottom ends of the wedge rings are less than those of top ends of the wedge rings.

As a further improvement of the technical solution, effluent troughs are arranged at bottom ends of the wedge rings, inner slots for water flow storage are arranged at inner ends of the wedge rings, and the inner slots keep communicating with inner ends of the effluent troughs.

As a further improvement of the technical solution, sponge rings are arranged at inner ends of the inner slots, section sizes of the sponge rings keep consistent with those of the inner ends of the inner slots, a plurality of extrusion rods are arranged at top ends of the sponge rings, and the extrusion rods stretch out of the top ends of the scraping rings and are connected with the top end of the reactor.

As a further improvement of the technical solution, limiting springs are arranged at top ends of the extrusion rods, and top ends of the limiting springs are connected with the top end of the reactor.

Compared with the prior art, the present disclosure has the following beneficial effects.

Firstly, in the coupled medium-low temperature flue gas processing apparatus for fly ash washing, arranging the scraping rings can scrape the fly ash adhered to the inside of the reactor and bring the scraped fly ash into a mixing liquor to prevent the fly ash from adhering and accumulating, which not only results in the decrease of the fly ash content participating in the reaction, and the difficulty to react with the water completely, but also the fly ash adhered to the inside of the reactor will form a thick object after mixing with the water, once the thick object is dried, the adhesive capacity thereof is greatly enhanced, causing the increase of the cleaning difficulty for the inside of the reactor in the later period, and at the same time, a mixing solution is subjected to a filtering treatment through the collection assembly, to separate the solid and the liquid therein.

Secondly, in the coupled medium-low temperature flue gas processing apparatus for fly ash washing, arranging the protective disk can further insulate the splashed mixing solution and perform a filtering treatment on the flue gas entering the inner end of the air inlet tube at the same time, to prevent the solid waste carried by the flue gas from entering the mixing solution, causing the great reduction of the washing effect.

Thirdly, in the coupled medium-low temperature flue gas processing apparatus for fly ash washing, a fitting degree between the bottom ends of the scraping rings and the inside of the reactor is improved by arranging the wedge rings, which further improves the cleaning effect for the fly ash adhered to the inside of the reactor.

Lastly, in the coupled medium-low temperature flue gas processing apparatus for fly ash washing, the water flow is stored in advanced by arranging the inner slots, in a scraping process of the wedge rings, the water flow stored at the inner ends of the inner slots flows into the inner ends of the effluent troughs along the inner ends of the inner slots and is discharged to the inner sides of the wedge rings through the effluent troughs, to flush the fly ash adhered to the inner sides of the wedge rings, making the fly ash reenter the mixing solution.

### BRIEF DESCRIPTION OF THE DRAWINGS

FIG. 1 is a schematic diagram of an overall structure of the present disclosure.

FIG. 2 is a section view of an overall structure of the present disclosure.

FIG. 3 is a structure section view of a reactor of the present disclosure.

FIG. 4 is a local enlarged diagram of part A in FIG. 3 of the present disclosure.

FIG. 5 is a local enlarged diagram of part B in FIG. 3 of the present disclosure.

FIG. 6 is a local enlarged diagram of part C in FIG. 3 of the present disclosure.

FIG. 7 is a structure section view of a scraping ring of the present disclosure.

FIG. 8 is a local enlarged diagram of part D in FIG. 7 of the present disclosure.

FIG. 9 is a local enlarged diagram of part E in FIG. 7 of the present disclosure.

### DETAILED DESCRIPTION OF THE EMBODIMENTS

The technical solution in the embodiments of the present disclosure is clearly and completely elaborated below in combination with the drawings in the embodiments of the present disclosure. It is apparent that the described embodiments are only a part of the embodiments of the present disclosure but not all. Based on the embodiments of the present disclosure, all the other embodiments obtained by those of ordinary skill in the art on the premise of not contributing creative effort should belong to the protection scope of the present disclosure.

In the description of the present disclosure, it is understood that orientation or position relationships indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, and the like are based on the orientation or position relationships as shown in the drawings, for ease of describing the present disclosure and simplifying the description only, rather than indicating or implying that the mentioned device or element necessarily has a particular orientation and must be constructed and operated in the particular orientation. Therefore, these terms should not be understood as limitations to the present disclosure.

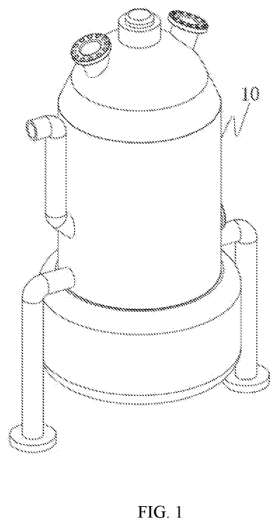

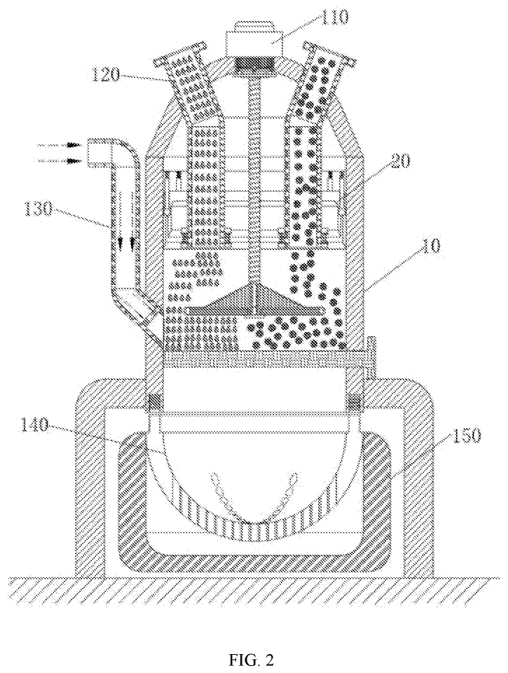

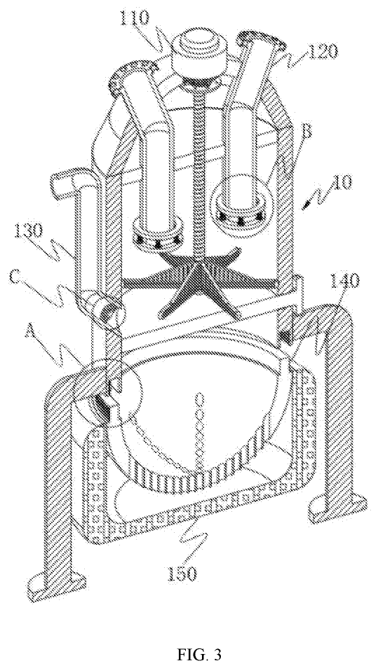

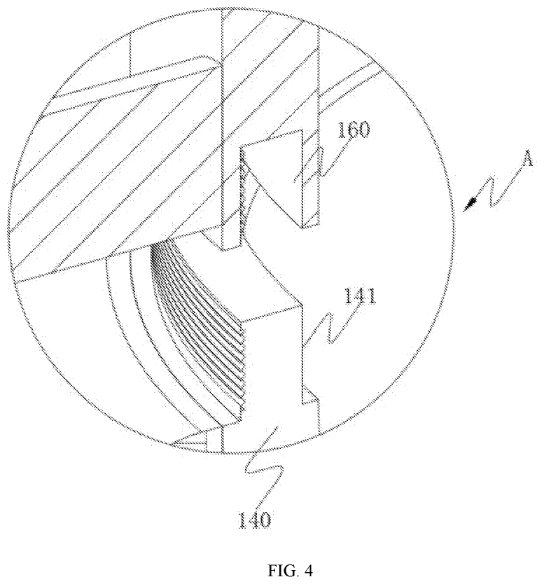

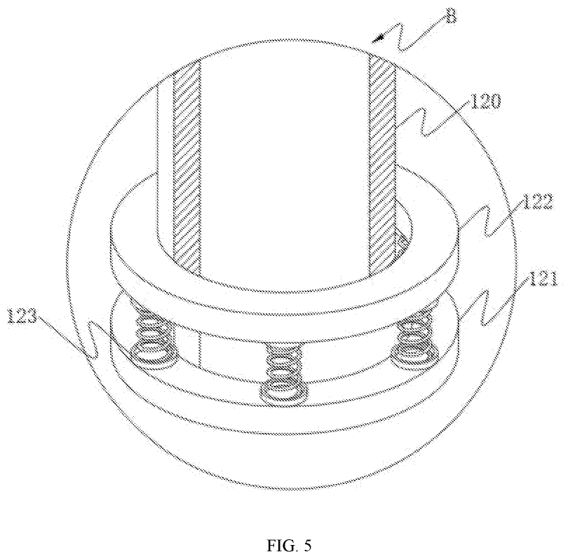

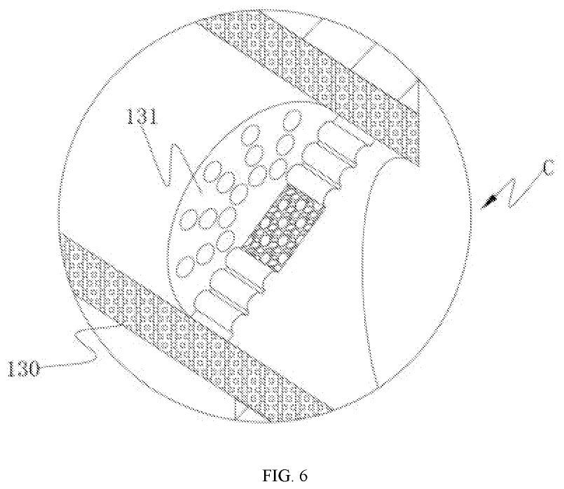

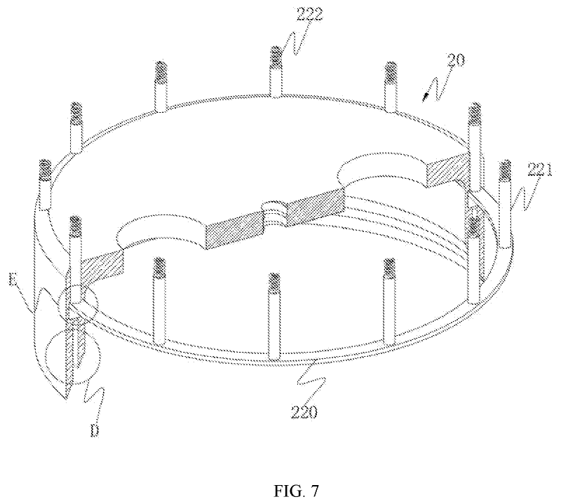

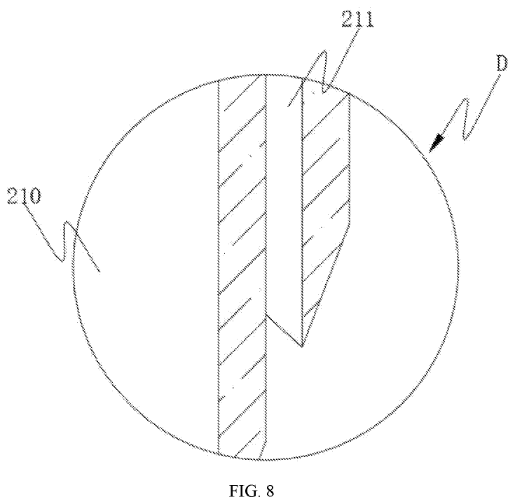

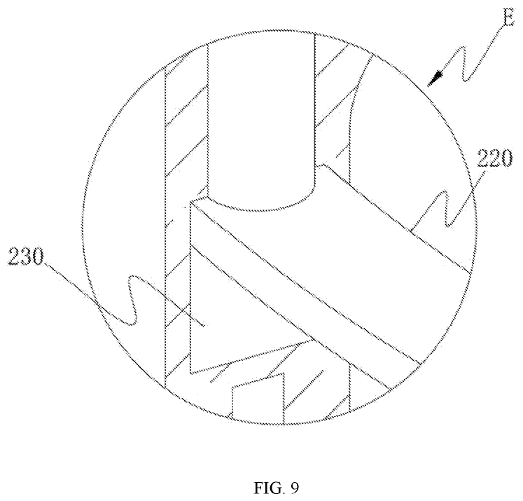

Please refer to FIG. 1-FIG. 9, a coupled medium-low temperature flue gas processing apparatus for fly ash washing is provided, including a reactor 10, where a stirring motor 110 is arranged in a middle of a top end of the reactor 10, feeding tubes 120 that are used for performing material guide work of fly ash and water are arranged on both sides of the top end of the reactor 10, an air inlet tube 130 used for performing flue gas introduction is arranged on a side of the reactor 10, scraping rings 20 are arranged at a position where an inner end of the reactor 10 is close to a middle of the reactor 10, a bottom end of the stirring motor 110 is coaxially connected with threaded rods that pass through middle positions of the scraping rings 20 and keep a threaded connection with the scraping rings 20, bottom ends of the threaded rods are coaxially connected with stirring rods, and a collection assembly used for collecting a mixture of the fly ash and the water is arranged at a bottom end of the reactor 10.

Edge positions of bottom ends of the scraping rings 20 keep fitting with the inside of the reactor 10, the stirring motor 110 drives the stirring rods to rotate through the threaded rods so as to perform a stirring treatment on the fly ash and the water, when the stirring motor 110 rotates forwards during stirring, the scraping rings 20 are driven to move down along the inside of the reactor 10 through the threaded rods, so the fly ash adhered to the inside of the reactor 10 is scraped at the edge positions of the bottom ends of the scraping rings 20, and when the stirring motor 110 rotates reversely, the scraping rings 20 are driven to move up along the inside of the reactor 10 through the threaded rods, to restore an initial position.

During specific use, the fly ash is introduced to the inner end of the reactor 10 through one feeding tube 120 and at the same time the water is introduced to the inner end of the reactor 10 through the other feeding tube 120, and a mixing mass ratio of the fly ash to the water is 1:4; after both the fly ash and the water are introduced to the inner end of the reactor 10, the stirring motor 110 is turned on, and the stirring motor 110 drives the stirring rods to stir and mix the fly ash and the water through the threaded rods; when the stirring motor 110 rotates forwards, the threaded rods rotate forwards, the scraping rings 20 are driven to move down along the inside of the reactor 10, edge positions of bottom ends of the scraping rings 20 keep fitting with the inside of the reactor 10, so the fly ash adhered to the inside of the reactor 10 is scraped during movement of the scraping rings 20 and brought into the mixing liquor; when the stirring motor 110 rotates reversely, the threaded rods rotate reversely, and the scraping rings 20 are driven to move up along the inside of the reactor 10, promoting the scraping rings 20 to restore an initial position and so on to clean the inside of the reactor 10 continuously; after being mixed fully, the fly ash and the water will form the mixing solution, sodium chloride and sodium sulfate salt in the fly ash are dissolved out, the afterheat flue gas of a power plant is introduced into the inner end of the reactor 10 through the air inlet tube 130 and mixed with the mixing solution, the dissolving rate of the sodium chloride and sodium sulfate salt in the fly ash is accelerated through the heat of the afterheat flue gas, and after the washing work is completed, the mixing solution is subjected to a filtering treatment through the collection assembly, to separate the solid and the liquid therein.

In the present disclosure, arranging the scraping rings 20 can scrape the fly ash adhered to the inside of the reactor 10 and bring the scraped fly ash into the mixing liquor to prevent the fly ash from adhering and accumulating, which not only results in the decrease of the fly ash content participating in the reaction, and the difficulty to react with the water completely, but also the fly ash adhered to the inside of the reactor 10 will form a thick object after mixing with the water, once the thick object is dried, the adhesive capacity thereof is greatly enhanced, causing the increase of the cleaning difficulty for the inside of the reactor 10 in the later period, and at the same time, the mixing solution is subjected to a filtering treatment through the collection assembly, to separate the solid and the liquid therein.

In addition, the collection assembly includes a filter funnel 140 that is sleeved at the bottom end of the reactor 10 and keeps communicating with the inner end of the reactor 10, a valve is arranged at a position where the inside of the reactor 10 is close to the bottom end of the reactor 10, the valve is used for controlling a switch between the bottom end of the reactor 10 and the inner end of the filter funnel 140, and a liquid tank 150 is arranged at a bottom end of the filter funnel 140. During specific use, after the washing work for the fly ash and water is end, the fly ash and the water form the mixing solution, at this time the valve is rotated such that the valve rotates from a horizontal state to a vertical state, a bottom end of the reactor 10 is opened, the mixing solution falls into the filter funnel 140 in this case, the mixing solution is subjected to a filtering treatment through the filter funnel 140, the solid in the mixing solution leaves to the inner end of the filter funnel 140 after the completion of filtering, and the liquid in the mixing solution will flow into the inner end of the liquid tank 150 through the filtering funnel 140, to complete the filtering work for the mixing solution.

Since the scraping rings 20 will move up and down along the two feeding tubes 120 in a process that the scraping rings 20 move up and down to scrape the fly ash, the scraping rings 20 are very easy to separate out from the bottom ends of the feeding tubes 120 in a process of sliding down, leading to overslipping and very easy contact with the stirring rods in a rotating process; further, fixed rings 121 are arranged at bottom ends of the feeding tubes 120, section sizes of the fixed rings 121 are greater than those of the feeding tubes 120, connecting rings 122 are sleeved at positions where the feeding tubes 120 are close to the bottom end, and a plurality of buffer springs 123 are connected between the connecting rings 122 and the fixed rings 121; the bottom ends of the feeding tubes 120 are subjected to a limiting treatment by arranging the fixed rings 121, the scraping rings 20 that are about to slide out of the the bottom ends of the feeding tubes 120 are hindered through the fixed rings 121, and meanwhile arranging the connecting rings 122 and the buffer springs 123 plays a role in buffering the scraping rings 20; and when the bottom ends of the scraping rings 20 are in contact with the top ends of the connecting rings 122, the scraping rings 20 will exert pressure to the connecting rings 122, so the connecting rings 122 slide along the feeding tubes 120 and extrude various buffer springs 123 to promote the contraction of the buffer springs 123, and during contraction, the buffer springs 123 will provide an opposite acting force to the connecting rings 122 to counteract the pressure on the connecting rings 122, play a buffer role for the sliding of the scraping rings 20, and reduce the damage caused after the connecting rings 122 collide with the scraping rings 20.

Since the mixing solution will be driven to splash at will in the inner end of the the reactor 10 in a stirring process and the bottom end of the air inlet tube 130 is in an opened state, the liquid is very easy to enter the inner end thereof along the bottom end of the air inlet tube 130 in a splashing process, and in the long run, a phenomenon that the inner end of the air inlet tube 130 is blocked will be caused, making the great decrease of the flue gas intake; and further, a bottom end of the air inlet tube 130 is an inclined structure, the air inlet tube 130 stretches downwards into the inner end of the reactor 10, designing the bottom end of the air inlet tube 130 to the inclined structure reduces the splashing quantity of the mixing solution, even the mixing solution is splashed into the inner end of the air inlet tube 130, itself gravity can also overcome the frictional force thereof, to promote the mixing solution to flow into the inner end of the reactor 10 again along the inner end of the air inlet tube 130, and avoid the blocking phenomenon occurred to the inner end of the air inlet tube 130.

Specifically, a protective disk 131 is arranged at an inner end of the air inlet tube 130, and a section size of the protective disk 131 keeps fitting with that of the inner end of the air inlet tube 130. Arranging the protective disk 131 can further insulate the splashed mixing solution and perform a filtering treatment on the flue gas entering the inner end of the air inlet tube 130 at the same time, to prevent the solid waste carried by the flue gas from entering the mixing solution, causing the great reduction of the washing effect.

In addition, a threaded ring 141 is arranged at a top end of the filter funnel 140, an internal thread 160 is arranged inside the bottom end of the reactor 10, and the threaded ring 141 keeps a threaded connection with the internal thread 160. When the inner ends of the liquid tank 150 and the filter funnel 140 are full, the filter funnel 140 and the liquid tank 150 are promoted to be separated from the bottom end of the reactor 10 by rotating the filter funnel 140, then the solid and liquid accumulated in the inner ends of the filter funnel 140 and the liquid tank 150 are taken out in time to prevent the excessive accumulation in the inner ends of the filter funnel 140 and the liquid tank 150, causing that the liquid in the inner end of the filter funnel 140 cannot enter the inner end of the liquid tank 150 smoothly, to reduce the filtering effect thereof.

Further, wedge rings 210 are arranged at the bottom ends of the scraping rings 20, and section sizes of bottom ends of the wedge rings 210 are less than those of top ends of the wedge rings 210. During specific use, a fitting degree between the bottom ends of the scraping rings 20 and the inside of the reactor 10 is improved by arranging the wedge rings 210, which further improves the cleaning effect for the fly ash adhered to the inside of the reactor 10.

After the wedge rings 210 scrape the fly ash, a small amount of fly ash is easily adhered to the inner sides thereof, further effluent troughs 211 are arranged at bottom ends of the wedge rings 210, of which the inner ends are provided with inner slots 230 for water flow storage, the inner slots 230 keep communicating with the inner ends of the effluent troughs 211, the water flow is stored in advanced by arranging the inner slots 230, in a scraping process of the wedge rings 210, the water flow stored at the inner ends of the inner slots 230 flows into the inner ends of the effluent troughs 211 along the inner ends of the inner slots 230 and is discharged to the inner sides of the wedge rings 210 through the effluent troughs 211, to flush the fly ash adhered to the inner sides of the wedge rings 210, making the fly ash reenter the mixing solution.

In addition, sponge rings 220 are arranged at inner ends of the inner slots 230, section sizes of the sponge rings 220 keep consistent with those of the inner ends of the inner slots 230, a plurality of extrusion rods 221 are arranged at top ends of the sponge rings 220, and the extrusion rods 221 stretch out of the top ends of the scraping rings 20 and are connected with the top end of the reactor 10. During specific use, the sponge rings 220 are made of sponge, with a relatively high water absorption effect, when the scraping rings 20 move up, top ends of the extrusion rods 221 are blocked by the top ends of the scraping rings 20 to promote the sponge rings 220 to slide down along the inner ends of the inner slots 230, when bottom ends of the sponge rings 220 are in contact with bottom ends of the inner slots 230, the sponge rings 220 will be extruded, to promote the deformation of the sponge rings 220, the water flow absorbed by the inner ends of the sponge rings 220 overflows to the inner ends of the sponge rings 220 again, flows into the inner ends of the effluent troughs 211 along the inner ends of the inner slots 230, and flows along the inner sides of the wedge rings 210, to improve the water storage efficiency of the inner ends of the inner slots 230.

In addition to this, limiting springs 222 are arranged at top ends of the extrusion rods 221, and top ends of the limiting springs 222 are connected with the top end of the reactor 10. During specific use, the top ends of the extrusion rods 221 are subjected to a buffer treatment by arranging the limiting springs 222, the extrusion rods 221 will exert pressure to the limiting springs 222 when moving down and being blocked by the top end of the reactor 10, to promote the contraction of various limiting springs 222, a counter acting force generates to the extrusion rods 221 to play a buffer role on the extrusion rods 221, thus preventing the quick overflow of the absorbed water flow due to excessive extrusion of the sponge rings 220, and the great decrease of the water storage effect of the sponge rings 220.

The basic principles, main characteristics and advantages of the present disclosure are shown and described above. Those skilled in the art shall understand that the present disclosure is not limited by the above embodiments, the above embodiments and specification describe the preferred embodiments of the present disclosure merely, are not intended to limit the present disclosure. Various changes and improvements will be made without deviating from the spirit and scope of the present the disclosure, and all of these fall within the protection scope of the present disclosure. The protection scope of the present disclosure is defined by the appended claims and their equivalents

What is claimed is:

1. A coupled medium-low temperature flue gas processing apparatus for fly ash washing, comprising a reactor, wherein
a stirring motor is arranged in a middle of a top end of the reactor, feeding tubes that are used for performing material guide work of fly ash and water are arranged on both sides of the top end of the reactor, an air inlet tube used for performing flue gas introduction is arranged on a side of the reactor, scraping rings are arranged at a position where an inner end of the reactor is close to a middle of the reactor, a bottom end of the stirring motor is coaxially connected with threaded rods that pass through middle positions of the scraping rings and keep a threaded connection with the scraping rings, bottom ends of the threaded rods are coaxially connected with stirring rods, and a collection assembly used for collecting a mixture of the fly ash and the water is arranged at a bottom end of the reactor;
edge positions of bottom ends of the scraping rings keep fitting with the inside of the reactor, the stirring motor drives the stirring rods to rotate through the threaded rods so as to perform a stirring treatment on the fly ash and the water, when the stirring motor rotates forwards during stirring, the scraping rings are driven to move down along the inside of the reactor through the threaded rods, so the fly ash adhered to the inside of the reactor is scraped at the edge positions of the bottom ends of the scraping rings, and when the stirring motor rotates reversely, the scraping rings are driven to move up along the inside of the reactor through the threaded rods, to restore an initial position;
the collection assembly comprises a filter funnel that is sleeved at the bottom end of the reactor and keeps communicating with the inner end of the reactor, a valve is arranged at a position where the inside of the reactor is close to the bottom end of the reactor, the valve is used for controlling a switch between the bottom end of the reactor and the inner end of the filter funnel, and a liquid tank is arranged at a bottom end of the filter funnel;
fixed rings are arranged at bottom ends of the feeding tubes, section sizes of the fixed rings are greater than those of the feeding tubes, connecting rings are sleeved at positions where the feeding tubes are close to the bottom end, and a plurality of buffer springs are connected between the connecting rings and the fixed rings;
a bottom end of the air inlet tube is an inclined structure, and the air inlet tube stretches downwards into the inner end of the reactor;
a protective disk is arranged at an inner end of the air inlet tube, and a section size of the protective disk keeps fitting with that of the inner end of the air inlet tube;
a threaded ring is arranged at a top end of the filter funnel, an internal thread is arranged inside the bottom end of the reactor, and the threaded ring keeps a threaded connection with the internal thread;
wedge rings are arranged at the bottom ends of the scraping rings, and section sizes of bottom ends of the wedge rings are less than those of top ends of the wedge rings;
effluent troughs are arranged at bottom ends of the wedge rings, inner slots for water flow storage are arranged at inner ends of the wedge rings, and the inner slots keep communicating with inner ends of the effluent troughs;
sponge rings are arranged at inner ends of the inner slots, section sizes of the sponge rings keep consistent with those of the inner ends of the inner slots, a plurality of extrusion rods are arranged at top ends of the sponge rings, and the extrusion rods stretch out of the top ends of the scraping rings and are connected with the top end of the reactor; and
limiting springs are arranged at top ends of the extrusion rods, and top ends of the limiting springs are connected with the top end of the reactor.
